(19) United States
(12) Patent Application Publication
(10) Pub. No.: US 2012/0131755 A1
(43) Pub. Date: May 31, 2012

(54) DOCK LEVELER FOR LOADING DOCK WITH INTEGRAL ON-DEMAND COMPRESSOR AND PNEUMATIC ACTUATOR

(75) Inventors: Chi LUU, Markham (CA); Gregory ION, Richmond Hill (CA)

(73) Assignee: BLUE GIANT EQUIPMENT CORPORATION, Brampton (CA)

(21) Appl. No.: 13/349,902

(22) Filed: Jan. 13, 2012

Related U.S. Application Data
(63) Continuation-in-part of application No. 12/764,553, filed on Apr. 21, 2010.

(51) Int. Cl. B65G 69/34

(52) U.S. Cl. 14/71.3

(57) ABSTRACT

A loading dock leveler with: a base; and a deck with a top platform, the deck having an inward end hingedly mounted to the inward end of the base for movement between an upper position and a lower position; an air compressor having a compressor capacity defined as a predetermined volume of compressed air delivered at a predetermined pressure delivered during a predetermined time period; a pneumatic deck lift actuator, comprising a pneumatic cylinder pivotally connected to the base and to the deck for rotary movement wherein the direct communication between the lift actuator inlet port and the compressor outlet, without a compressed air storage receiver tank, delivers compressed air directly from the compressor to the lift chamber at the compressor capacity within a lift actuation time period, and wherein the lift chamber volume divided by the compressor capacity equals the lift actuation time period.

### TECHNICAL FIELD

The invention relates to a dock leveler with a movable deck having an integral on-demand air compressor directly connected to a pneumatic actuator to move the deck between a downward and an upward inclination.

### BACKGROUND OF THE ART

Loading dock levelers or ramps are commonly used for providing an inclined ramp or a level bridge between the surface of a transport truck deck and the floor surface of a loading dock of a building thereby facilitating the loading and unloading of the truck by wheeled vehicles, such as forklift trucks or pallet trucks, as well as pedestrian or animal traffic.

Transport trucks have load carrying decks that vary in height above the pavement depending on the size of truck, the intended use of the transport truck and the state of compression that the truck suspension is in when loaded or unloaded. Since any truck arriving at a dock may have a deck within a range of heights and the height can float with the suspension under loading, the loading dock leveler must be able to move vertically. The dock leveler usually pivots from a fixed pivot point on the inner end secured to a building and the outside end rotates about the pivot point to ultimately rest on the top surface of the truck deck. The movable deck of the dock leveler usually has a main deck that pivots from the building and an outside lip plate that is thin and of relatively short length that pivots on the outside end of the main deck to provide a smooth ramp or transition between the truck deck surface and the main deck.

In many environments the use of hydraulic oil actuators is not acceptable due to the risk of contamination by oil leaks, health or other safety concerns. For example in food or drug processing, handling or distribution facilities the use of pressurized air actuators are chosen to eliminate the risk of contaminating these consumable products or their packaging with oil that leaks from hydraulic actuators.

Traditionally, relatively large air compressors are used in manufacturing, warehousing and shipping environments to provide all of the compressed air needs for a facility from a centralized source. Due to the multiple demands on the compressed air supply, traditionally a central compressor with a large storage tank or accumulator and centralized oil/water separator has been found to be the most efficient in terms of purchase price, operating costs and maintenance demands. Compressed air is relatively safe without shock or explosion hazards. Compressed air driven equipment can accommodate multiple simultaneous demands for air power with rapid supply provided from a reserve of compressed air in a storage tank or accumulator.

Recent years have seen air compressors being used beyond the traditional manufacturing and automotive repair environments. Light weight, inexpensive, portable air compressors are now also common in construction and home workshop environments to power pneumatic nail guns, grinders, paint sprayers and other common household or construction tools.

Consumer demand for air compressors and pneumatic tools has resulted in such equipment being commonplace in local building supply, hardware, and automotive supply stores. As a consequence small capacity air compressors have been produced in large quantities making low cost reliable compressors easily available for purchase and with rapid maintenance, warranties and replacement like many other commonplace consumer appliances.

Such consumer directed air compressors are generally sold with an air storage receiver tank for the same reasons that larger air compressors are paired with storage tanks. The storage of compressed air is considered as a desirable buffer to provide an immediate flow of a sufficient volume compressed air at a selected pressure to operate tools or equipment. The stored volume of compressed air also balances out the demand for compressed air from a single or multiple tools or other equipment. The store of compressed air enables the compressor to avoid being activated and deactivated in short cycles since the store of compressed air can provide short bursts of compressed air of sufficient quantity and pressure without requiring the compressor to activate. Of course the larger the storage tank, the larger the delay between initiating air withdrawal and compressor activation when the pressure decreases to below a minimum value. Therefore compressed air storage tanks are generally used in combination with air compressors to reduce the number of on/off cycles of the air compressor and electric motors driving the compressors. Air storage tanks are generally seen as a desirable and necessary part of a pneumatic circuit to provide sufficient compressed air at a desired pressure, to reduce damage from on/off switching of a compressor which maintains a long duty cycle for the electric motors and compressors. Most equipment with moving parts, switches and valves have a longer life span if they are run continuously for discrete periods, rather than being constantly turned on and off in rapid short bursts. The wear and tear of rapid on/off cycles shortens the service life and increases maintenance demands for most equipment.

Storage of compressed air in an accumulator tank is considered desirable to ensure that an adequate volume of compressed air is available at the required pressure for operation of tools. Storage of compressed air generally provides the benefits of: extending the life of the air compressor and electric motors driving them by reducing on/off cycling; avoiding delays in air tool operation by having an adequate charge of compressed air available continuously; and combining the demand for compressed air in a centralized source that allows averaging or balancing of the high demand and low demand. Centralizing compressed air supply also enables centralized cooling of compressed air, air/water/oil separation and moisture removal. Accordingly for these reasons, compressed air circuits generally include a compressed air storage tank also known as an accumulation tank.

Features that distinguish the present invention from the background art will be apparent from review of the disclosure, drawings and description of the invention presented below.

### DISCLOSURE OF THE INVENTION

The invention provides A loading dock leveler with: a base having an inward end; and a deck with a top platform, the deck having an inward end hingedly mounted to the inward end of the base for movement between an upper position and a lower position; an air compressor with an electrically powered motor, the compressor having inlet in communication with a source of ambient air and a compressed air outlet, the air compressor having a compressor capacity defined as a predetermined volume of compressed air delivered at a predetermined pressure delivered during a predetermined time period; a pneumatic deck lift actuator, comprising a pneumatic cylinder pivotally connected to the base and to the deck for rotary movement between a raised position and a lowered position, the lift actuator having a lift chamber with a lift chamber volume, and an inlet port in direct communication with the compressor outlet, without a compressed air storage receiver tank, through an electric powered lift valve to the lift chamber, and having a vent valve in communication with the lift chamber; and the loading dock leveler further comprising: an electric user control interface having: an electric up/down switch in communication with the motor to conduct electric power to the motor and open the lift valve in an up position, and to prevent conduction of electric power to the motor and open the vent valve in a down position; wherein the compressor, motor, lift valve; vent valve and lift actuator are disposed between the base and the deck; and wherein the direct communication between the lift actuator inlet port and the compressor outlet, without a compressed air storage receiver tank, delivers compressed air directly from the compressor to the lift chamber at the compressor capacity within a lift actuation time period, and wherein the lift chamber volume divided by the compressor capacity equals the lift actuation time period.

The present invention includes a dock leveler mechanism having an on-demand air compressor without an air storage tank to operate a pneumatic power actuator that improves performance, lowers cost and simplifies manufacturing and maintenance. Absence of a reserve of compressed air in an accumulator results in a slow activation of pneumatic tools or cylinders as the pressure gradually rises from zero to the operational pressure. Delay in activation is normally considered undesirable and storage of compressed air is considered necessary to ensure rapid actuation of air powered devices. In pneumatic systems, a delay in reaching operational pressure is generally undesirable because tools do not have adequate pressure to operate at all or tools are not operating at the optimal speed at all times or rapid actuation is part of the machinery requirements.

The inventors found that initial tests using an air compressor with an accumulator tank resulted in rapid actuation of the deck lift cylinder which can be dangerous and disturbing to users if not controlled with an air flow restrictor, for example. The storage of compressed air at high pressure being suddenly released to an actuating cylinder in many other situations is desirable since rapid actuation is required. Not so in the case of a heavy pivoting deck platform used outdoors adjacent transport trucks. Rapid deployment of the heavy deck is not desirable and the number of times a deck is moved daily is relatively low, so that rapid deployment is unnecessary. The inventors realized that actuating the pneumatic deck lifting cylinder gradually and slowly was preferable and that use of an air storage accumulator to deliver a large volume of high pressure air quickly was not required.

The air storage tank proved to be unnecessary because the compressor is inherently limited in capacity (standard cubic feet per minute) to deliver compressed air. The volume of compressed air required for lift actuation is relatively low, being at most the entire volume of the lift cylinder, which supports the conclusion that an air storage tank is not essential. The lift actuation time period, during which the compressor delivers compressed air directly to the lift cylinder, was significantly greater than the almost instantaneous delivery of compressed air to the lift cylinder from a fully charged air storage tank. However the longer lift actuation period proved to be beneficial rather than detrimental. A longer lift actuation period results in safer operation of the dock leveler by moving the deck slowly. The slower movement is inconsequential in operation because the number of times during a day that the deck must move is relatively low.

By directly connecting the compressor to the deck actuating pneumatic cylinder, without any air storage tank between them, allows the lift cylinder to be moved gradually. As the air pressure delivered from the compressor builds gradually from zero pressure to the operating pressure, the speed of the actuating cylinder gradually increases from no motion to full speed motion.

The resultant delay in actuation is advantageous to provide a gradual acceleration in the movement of a heavy deck platform, while generally a delay in pneumatic actuation in other situations is undesirable. Elimination of the air accumulator also reduces costs, reduces space requirements and in an outdoor environment avoids freezing of moisture that accumulates in a storage tank.

Further, the deck can include a lip plate hingedly mounted to a front edge thereof, the deck including a pneumatic lip actuator pivotally connected to the lip plate for rotary movement between a deployed position and a retracted position, the lip actuator having a deploy chamber, and an inlet port in direct communication with the compressor outlet through an electric powered lip deploy valve to the deploy chamber, and having a vent valve in communication with the deploy chamber. The electric user control interface may also have an electric deploy/retract switch in communication with the motor to conduct electric power to the motor and open the lip deploy valve in a deploy position, and to prevent conduction of electric power to the motor and open the vent valve in a retract position.

The on-demand nature of the direct connection between the air compressor and the pneumatic lift actuator and pneumatic deploy actuator has a number of advantages. The integral dedicated compressor uses minimal power since a store of compressed air is unnecessary and the actuators are pressurized only by as much compressed air that is needed. The actuators are independently operated by the controls and therefore only the movement required with the minimal air power required is used.

The dock leveler may be easily installed and maintained in environments that do not have compressed air available and where conventional dock levelers may be considered too expensive, too bulky and too complex. The compressor may be electrically powered with common 110 or 220 Volt AC electric power, so it is relatively simple to install. A low cost mass produced air compressor can be provided which is relatively inexpensive and the use of electrically powered on-demand compressor dedicated and integral to the dock leveler enables use of the leveler in many shipping environments that do not otherwise have any need for nor provision of compressed air.

The disposing of all operating components between the base and the deck in a clam-shell manner protects the exposed equipment from weather, debris, accidental damage and vandalism. These advantages make such dock levelers more accessible and practical for a wider range of potential purchasers as a result of the on-demand nature of the air compressor used.

### DESCRIPTION OF THE DRAWINGS

In order that the invention may be readily understood, one embodiment of the invention is illustrated by way of example in the accompanying drawings.

FIG. 1 is a front isometric view of a loading dock leveler with the deck in the upper position and the in the raised position.

FIG. 2 is a front view of the loading dock leveler of FIG. 1 in the raised position.

FIG. 3 is a sectional view of the loading dock leveler along line 3-3 of FIG. 2.

FIG. 4 is a top isometric view of the operating equipment within the enclosure including compressor, electric power source, solenoid switches and the deck lift actuation cylinder.

FIG. 5 is a schematic view of the pneumatic circuit.

Further details of the invention and its advantages will be apparent from the detailed description included below.

### DETAILED DESCRIPTION OF PREFERRED EMBODIMENTS

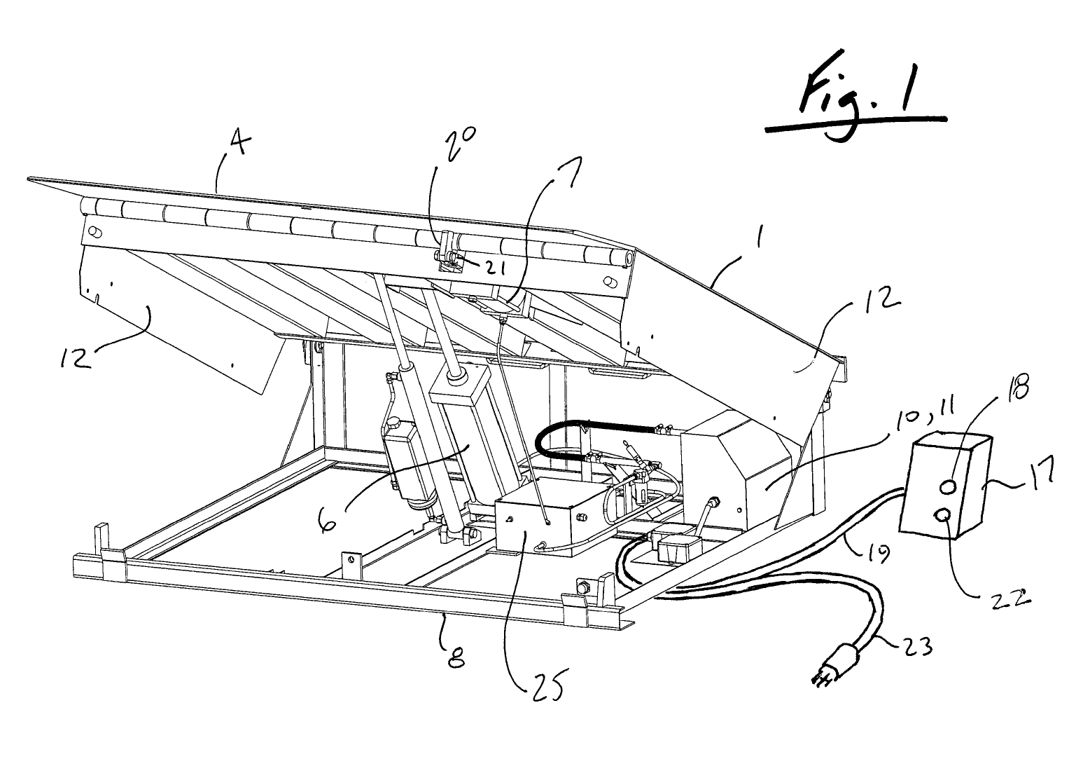

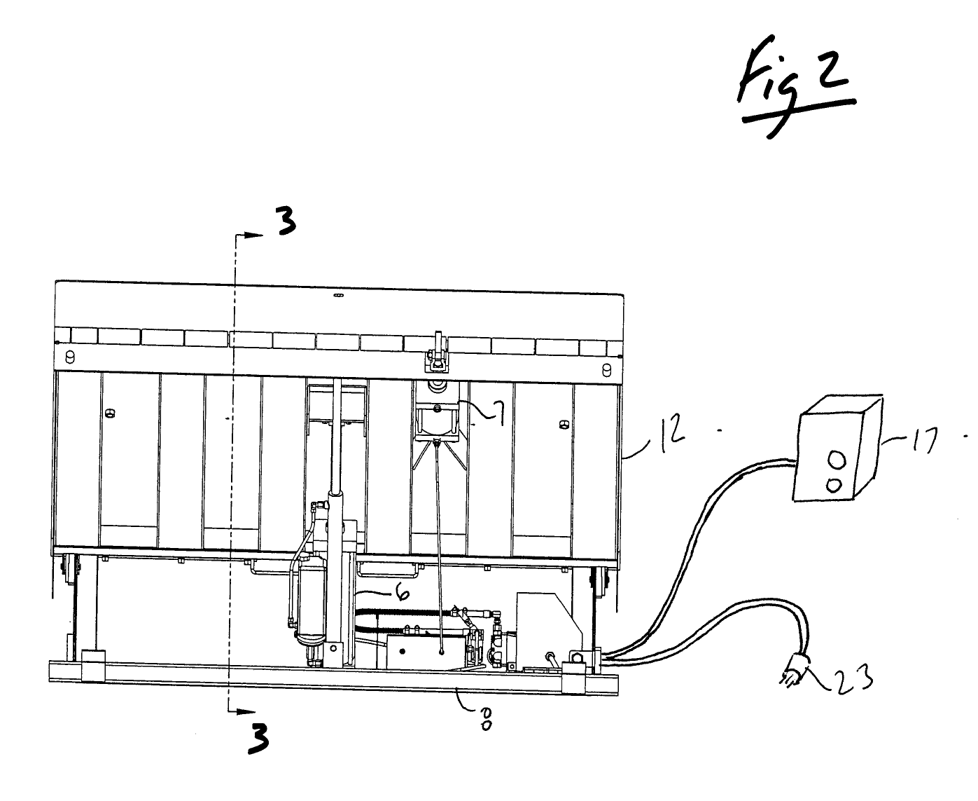

FIGS. 1-3 show the loading dock leveler which is generally rectangular and fits within a rectangular threshold recess adjacent a truck loading doorway in a building, or in the edge of a raised dock platform. The dock platform, and floor of the building are at the level of the rear of the dock leveler. The building and doorway are not shown since such arrangements are commonly known to those skilled in the art.

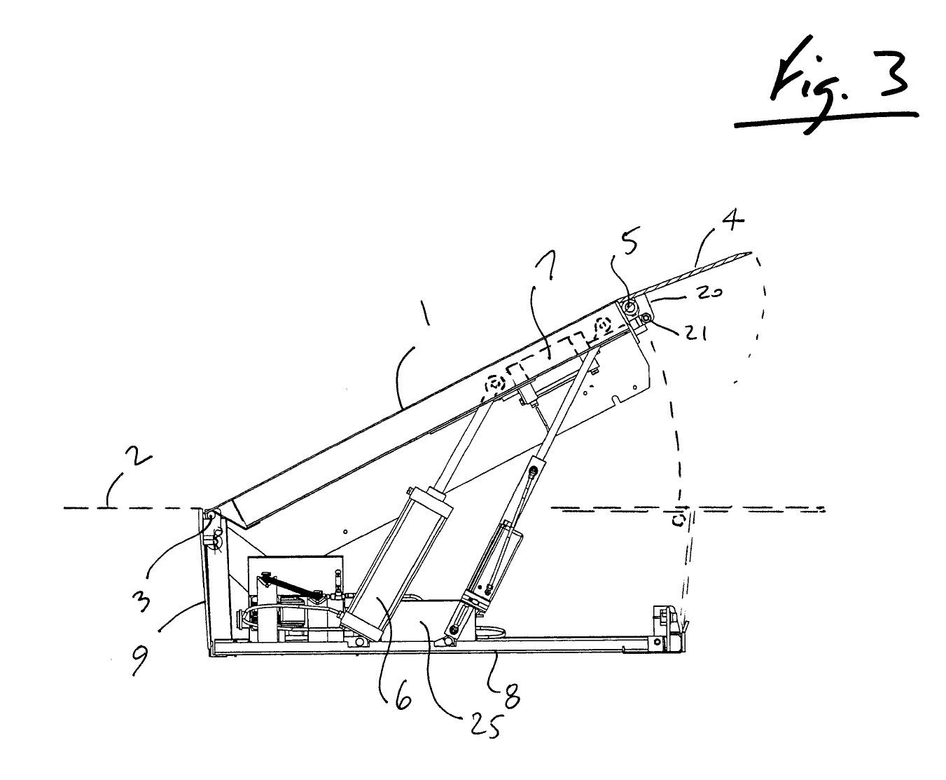

FIG. 3 shows the movable deck 1 of the dock leveler with a top platform surface on which wheeled vehicles, people or animals travel. The deck 1 pivots relative to the building floor 2 about a hinge pin 3. The outside lip plate 4 is relatively thin and of relatively short length to pivot on a pin 5 on the outside end of the main deck 1 and when lowered the lip plate 4 provides a smooth transition between the truck deck surface and adjacent main deck 1. The pneumatic lift actuator 6 moves the deck 1 of the dock leveler between the upper position and the lower position, and independently the lip plate 4 is moved between the deployed position and a retracted position by the lip actuator 7 as shown in FIG. 3 in particular.

FIGS. 1-3 show the loading dock leveler with deck 1 in its uppermost position and the lip plate 4 fully deployed. After a truck is backed up to the dock and secured, the deck 1 may be lifted and lip plate 4 deployed the minimum distance required to lay the lip plate 4 on the truck bed and provide a ramp or bridge between the building floor 2 and the truck bed (not shown).

The loading dock leveler is made up of a base 8 having two inward end posts 9 with the deck 1 having its inward end hingedly mounted to the inward end of the base 8 with a pin 3 for movement between the upper position illustrated and a lower position indicated in dashed outline in FIG. 3.

As seen in FIG. 1, an integral on-demand air compressor 10 with an associated electrically powered motor is shown inside a protective sheet metal housing 11. The electric motor of the compressor 10 can be simply powered with a 110 Volt AC power cord 23 with a standard three prong plug into a standard 110 Volt AC receptacle outlet. Optionally, 12 Volt DC battery powered compressors 10 are available and a battery can be housed within the same housing 11. Of course the clam-shell arrangement of the deck 1, base 8, side skirt plates 12 and retracted lip plate serve to encase all of the operating components in a compact protective enclosure.

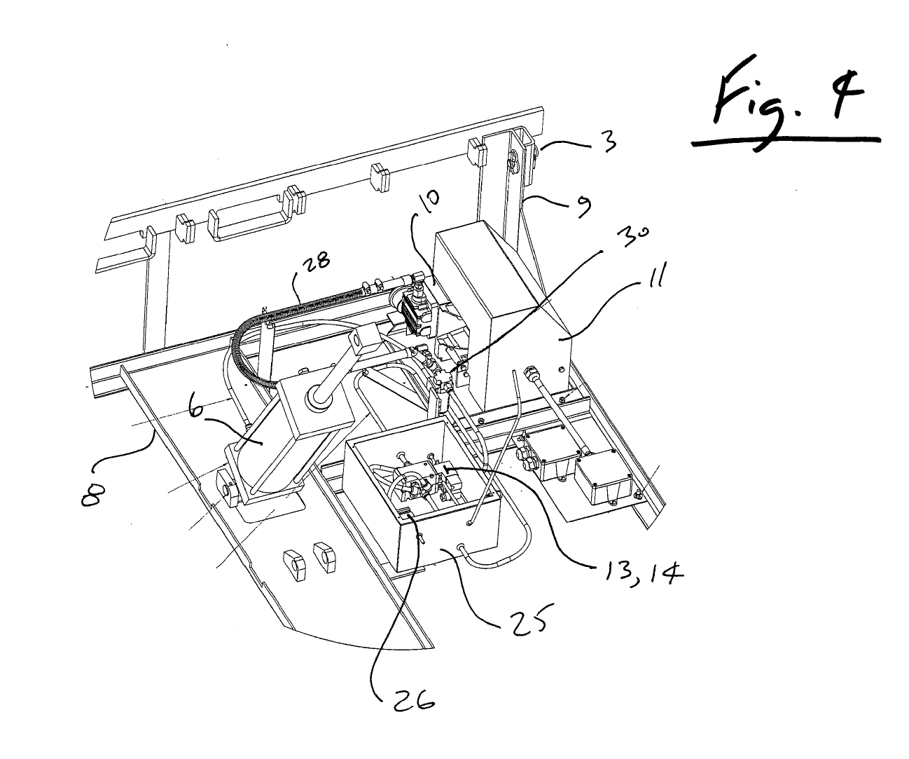

The compressor 10 has inlet in communication with a source of ambient air preferably through on air inlet filter and has a compressed air outlet that passes compressed air directly to the lift actuator 6 through the electrically powered lift valve 13 in. In a like manner the compressed air outlet of the compressor 10 that passes compressed air directly to the lip actuator 7 through the electrically powered lip deploy valve 14. FIG. 4 shows the lip deploy valve 14 and the lift valve 13 are disposed within a protective housing 25 that includes an internal electric heater with a thermostat control 26.

The pneumatic deck lift actuator 6 is pivotally connected to the base 8 at pin 15 and to the deck 1 at pin 16 (see FIG. 3) for rotary movement between the raised position and the lowered position. The lift actuator 6 having a pressurized air lift chamber, and an inlet port in direct communication with the compressor outlet through the electric powered lift valve 13 without the requirement of any air storage tank. The lift chamber of the lift actuator 6 is relatively large and corrosion resistant to receive pressurized air directly from the compressor 10 and eliminates any need for intermediate air storage tank because the air compressor serves only the two actuators 6, 7 that require little volume of air on a relatively low duty cycle when needed.

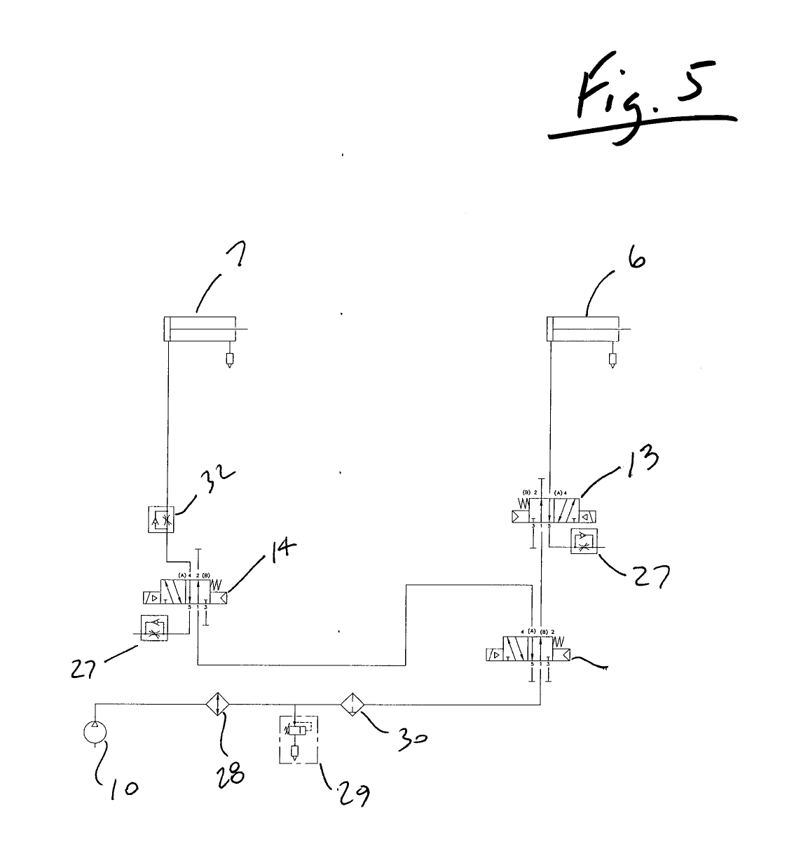

To release pressurized air from the lift actuator 6 the lift chamber is connected to a flow restricting vent valve 27 as illustrated in FIG. 5 to exhaust air to the atmosphere slowly. The air vents slowly through an air flow restrictor valve 27 so that a slow controlled downward movement results as opposed to a dangerous fast release. Of course the invention is equally applicable to double acting pneumatic cylinders where opposing sides of the piston within the cylinder are connected to alternating open/close pneumatic valves in a manner well known to those skilled in the art.

The on-demand integral compressor 10 has preferably a relatively high pressure for example 100-150 psi (pounds per square inch) whereas typical air compressors for shop use in factories or auto repair shops is provided at 80 psi. The on-demand compressor 10 is connected directly with a short length of pipe to the lift actuator 6 which reduces the risk of air leakage as well. The use of a minimal short pipe between the compressor 10 and the actuators 6, 7 ensures that the compressor 10 is only operated when movement of the actuators 6, 7 is needed.

An electric user control interface 17 has an electric up/down switch 18 in communication with the electric motor of the compressor 10 via control cable 19 to conduct electric power to the motor and open the lift valve 13 in an up position, and to prevent conduction of electric power to the motor and open the vent valve in a down position.

As best seen in FIGS. 1 and 3, the deck 1 includes a lip plate 4 hingedly mounted by a pin 5 to its front edge. On the underside of the deck 1 is mounted the pneumatic lip deploy actuator 7 pivotally connected to a lug 20 of the lip plate with pin 21 for rotary movement between the deployed position (solid lines at top of FIG. 3) and a retracted position (dashed lines at bottom of FIG. 3). The lip actuator 7 has a deploy chamber, and an inlet port in direct communication with the compressor outlet through the electric powered lip deploy valve 14 and the deploy chamber is connected to a vent valve portion at the bottom of the deploy valve 14 as illustrated to exhaust air to the atmosphere.

The electric user control interface 17 has an electric deploy/retract switch 22 in communication with the electric motor of the compressor 10 to conduct electric power to the motor and open the lip deploy valve 14 in a deploy position, and to prevent conduction of electric power to the motor of the compressor 10 and open the vent valve portion at the bottom of the deploy valve 14 as illustrated to exhaust air to the atmosphere to move the lip plate 4 to the retract position. Of course the lip deploy actuator 7 may also be configured as a double acting pneumatic cylinder if desired. The user interface 17 can be configured as a wireless remote transmitter with cooperating receiver communicating with the valves 13, 14.

FIG. 5 shows a schematic circuit for the pneumatics and FIG. 4 shows a detail of the physical layout. Compressed air from the compressor 10 passes through an air cooler coil 28 and a high pressure relief valve 29 to an air/water filter-separator 30. A toggle valve 31 selects between directing air to the lift actuator 6 or the lip actuator 7. In the conduit passing to the lip actuator 7 a flow restrictor 32 is located to further reduce the velocity of air flow and prevent rapid actuation of the lip 4 for safety reasons.

The above description relates to a specific preferred embodiment as presently contemplated by the inventor, it will be understood that the invention in its broad aspect includes mechanical and functional equivalents of the elements described herein.

1. A loading dock leveler comprising:
a base having an inward end; and
a deck with a top platform, the deck having an inward end hingedly mounted to the inward end of the base for movement between an upper position and a lower position;
an air compressor with an electrically powered motor, the compressor having inlet in communication with a source of ambient air and a compressed air outlet, the air compressor having a compressor capacity defined as a predetermined volume of compressed air delivered at a predetermined pressure delivered during a predetermined time period;
a pneumatic deck lift actuator, comprising a pneumatic cylinder pivotally connected to the base and to the deck for rotary movement between a raised position and a lowered position, the lift actuator having a lift chamber with a lift chamber volume, and an inlet port in direct communication with the compressor outlet, without a compressed air storage receiver tank, through an electric powered lift valve to the lift chamber, and having a vent valve in communication with the lift chamber; and
the loading dock leveler further comprising:
an electric user control interface having:
an electric up/down switch in communication with the motor to conduct electric power to the motor and open the lift valve in an up position, and to prevent conduction of electric power to the motor and open the vent valve in a down position;
wherein the compressor, motor, lift valve; vent valve and lift actuator are disposed between the base and the deck; and
wherein the direct communication between the lift actuator inlet port and the compressor outlet, without a compressed air storage receiver tank, delivers compressed air directly from the compressor to the lift chamber at the compressor capacity within a lift actuation time period, and wherein the lift chamber volume divided by the compressor capacity equals the lift actuation time period.

2. The loading dock leveler according to claim 1, wherein:
the enclosure deck includes a lip plate hingedly mounted to a front edge of the deck thereof;
the operating equipment includes deck including a pneumatic lip actuator pivotally, comprising a pneumatic cylinder connected to the lip plate for rotary movement between a deployed position and a retracted position, the lip actuator having a deploy chamber with a deploy chamber volume, and an inlet port in direct communication with the compressor outlet, without a compressed air storage receiver tank, through an electric powered lip deploy valve to the deploy chamber, and having a vent valve in communication with the deploy chamber; and
wherein the direct communication between the lip actuator inlet port and the compressor outlet, without a compressed air storage receiver tank, delivers compressed air directly from the compressor to the deploy chamber at the compressor capacity within a lip actuation time period, and wherein the deploy chamber volume divided by the compressor capacity equals the lip actuation time period.

3. The loading dock leveler according to claim 2, wherein:
the electric user control interface has an electric deploy/retract switch in communication with the motor to conduct electric power to the motor and open the lip deploy valve in a deploy position, and to prevent conduction of electric power to the motor and open the vent valve in a retract position; and
wherein the lip deploy valve and lip actuator are disposed within the enclosure between the base and the deck.

4. The loading dock leveler according to claim 2, wherein:
at least one of: the lip deploy valve; and the lift valve are disposed within a housing; and
the housing including an internal electric heater with a thermostat control.

5. The loading dock leveler according to claim 1 wherein:
the enclosure includes a left side skirt plate and a right side skirt plate.
